(19) United States
(12) Patent Application Publication
(10) Pub. No.: US 2008/0005953 A1
(43) Pub. Date: Jan. 10, 2008

(54) Line guides for fishing rods

(75) Inventor: Mark C. Anderson, Minnetonka, MN (US)

Correspondence Address: KAGAN BINDER, PLLC, SUITE 200, MAPLE ISLAND BUILDING, 221 MAIN STREET NORTH, STILLWATER, MN, 55082, US

(73) Assignee: Anderson Tackle Company

(21) Appl. No.: 11/823,605

(22) Filed: Jun. 28, 2007

Related U.S. Application Data
(60) Provisional application No. 60/819,191, filed on Jul. 7, 2006.

(51) Int. Cl. A01K 87/04

(52) U.S. Cl. 43/24

(57) ABSTRACT

Line guides for fishing rods made from one or more materials including an amorphous metallic alloy, sometimes referred to as a metallic glass. In preferred embodiments, the line guide has a one-piece structure and more preferably is formed substantially entirely from metallic glass. The present invention also relates to fishing rods incorporating such line guides.

### PRIORITY CLAIM

The present non-provisional patent Application claims priority under 35 U.S.C. § 119(e) from United States Provisional Patent Application having Ser. No. 60/819,191, filed on Jul. 7, 2006, by Mark C. Anderson and titled LINE GUIDES FOR FISHING RODS, wherein the entirety of said provisional patent application is incorporated herein by reference.

### FIELD OF THE INVENTION

The present invention relates generally to fishing rods and fishing rod components and is more particularly concerned with new and improved fishing rod guides for use on fishing rods.

### BACKGROUND OF THE INVENTION

Line guides, also knows as rod guides, have been used on fishing rods to help guide the fishing line along the length of the rod. A typical guide includes a base and a frame attached to the base. The base sometimes is referred to as a shoe and is shaped to fit tightly against the rod. The frame includes an aperture through which the line is routed. Line guides provide guidance both during fishing line deployment (e.g., casting, spinning, etc.) as well as when the line is tensioned and/or recovered.

There are two main kinds of fishing rods in widespread use. A bait casting rod generally includes a reel holding a supply of fishing line mounted onto an upper side of a rod. Line guides help guide the fishing line along the top of the rod as well. A spinning rod includes a reel holding a supply of fishing line mounted to an underside of a rod. Line guides help to guide the fishing line along the underside of the rod as well. Line guides are used on both kinds of rods. A typical fishing rod includes from two to about fifteen line guides.

Line guides significantly impact the performance of a fishing rod. Yet, designing effective line guides often involves balancing competing concerns. For instance, the mass of a line guide can impact the overall weight and action of the rod. Generally, it is desirable that a line guide be as lightweight as practically feasible. However, if too lightly constructed, a line guide might have poor mechanical strength, durability, abrasion resistance, deformation resistance, and/or the like.

The length of the shoe of a line guide tends to reduce the flexibility of a rod to some degree. Generally, longer shoes tend to inhibit flexibility more than shorter shoes. However, shorter shoes tend to be weaker and do not provide as much support for the line guide frame as longer shoes.

A line guide also impacts the degree to which a fishing rod might twist during use. Excessive twisting desirably is avoided in order to enhance rod control when a line is tensioned. One way to inhibit twisting is to maintain the fishing line close to the rod body, or at least that portion of the rod body close to the rod tip. This minimizes the twisting moment. However, if a line is maintained too close to the rod body during casting, casting controllability and/or casting distance may be impaired.

In order to more easily release line entanglement, the frame of a line guide desirably is tilted forward to some degree toward the tip of the rod. However, the attachment of the frame to its base must generally be more robust to accommodate this tilt and adequately brace and support the frame. Conventionally, this might require heavier or more supporting structure and/or a longer base.

The forces between at least the frame of a guide and a line being guided through the frame can be quite significant. In view of such forces, it is desirable to minimize friction, abrasion, heat build-up, and the like between the frame and the line.

One would think that a conventional line guide could be fabricated simply and in one piece. This is not the case with respect to many commercially available line guides, because so-called “one-piece” line guides might tend to lack the strength, durability, impact resistance, and/or deformation resistance to be practically useful. The integrity of the guides is further confounded by the tendency of conventionally used metal formulations to be relatively incompatible as much as might be desired with respect to one-step fabrication processes, e.g., injection molding, casting processes, and the like. As one problem, the formed part tends to shrink too much and/or develop too much porosity upon cooling. It is believed that this occurs in that conventionally used molten metal goes through a liquid-to-solid transformation that can result in a sudden, discontinuous volume change upon solidification. Whatever the mechanism, the resulting part may suffer from low metallurgical soundness and quality.

Molding and casting problems are severe enough that, notwithstanding the added manufacturing complexity, commercial line guides quite often are manufactured in multiple steps by forming and attaching (e.g., welding) two or more parts together. As an option after welding, the line guide could be heat-treated. Such multi-step manufacturing of commercial line guides can reduce and/or complicate manufacturing yield. The extra steps also significantly manufacturing time and cost.

The use of multiple parts and multi-step manufacturing limits design flexibility in that it becomes uneconomical for a line guide manufacturer to invest in tooling for additional line guide designs. It would be very desirable to simplify the manufacture of line guides. It would also be desirable to ease the economics of developing and manufacturing additional line guide designs.

Additionally, line guides might be damaged and/or lost for one reason or another, requiring replacement. Line guides might fail for a variety of reasons. For example, many of the materials (e.g., stainless steel) conventionally used to make line guides start to corrode soon after being exposed to the open-ocean waters (i.e., salt-water). A line guide might quickly corrode to a point such that its ability to function adequately is seriously compromised. A severely corroded line guide is also more prone to damage and/or loss.

The impact resistance of conventional metal parts themselves (e.g., stainless steel line guides) may be such that a large fish can pull on a line with such force that the line guide literally snaps apart and falls from the fishing rod. In such a case, the utility of the line guide is completely lost.

The materials used to fabricate many conventional commercial line guides can be susceptible to undue deflection during use, if stepped upon, when packed with other gear, or the like. Deflecting to an undue degree causes the utility of the guide to be reduced or lost. The resulting deformation could be permanent, requiring replacement or repair. Some conventional line guides tend to lack the memory required for the guide to naturally return to a position after a deformation such that the guide's utility is regained.

If the utility of a line guide is lost or reduced to an undue degree, a new guide is desirably attached to the rod to replace the old one. Replacing guides can involve significant labor, material, cost, and down time of a fishing rod. The factors associated with attaching and replacing, as needed, line guides can be significant. It would be desirable to reduce the labor, materials, costs, and down time associated with maintaining fishing rods so that a fishing vessel and its crew can spend more time fishing and less time getting ready to fish.

There is a continuing need for new and improved line guides, whether for recreational or commercial fishing.

### SUMMARY OF THE INVENTION

The present invention provides line guides made from one or more materials including an amorphous metallic alloy, sometimes referred to as a metallic glass. In preferred embodiments, the line guide has a one-piece structure and more preferably is formed substantially entirely from metallic glass. The present invention also relates to fishing rods incorporating such line guides.

Line guides made from metallic glasses have many advantages uniquely beneficial in the fishing industry. Firstly, as one consequence of the high yield strength, superior elastic limit, high corrosion resistance, high hardness, superior strength-to-weight ratio, high wear-resistance, and others associated with metallic glasses, line guides made from such materials can be fabricated, if desired, using casting and molding processes in one step and, if desired, in one unitary piece. The metallic glass material is compatible with such fabrication processes and the resultant line guides are quite strong and durable in contravention to conventional wisdom associated with line guide manufacture and use.

Also, being able to form a unitary, undivided line guide of the present invention via, e.g., injection molding can increase development and design flexibility.

Line guides made from one or more materials including metallic glass would tend to have significantly longer-lasting utility than conventionally formulated guides. Because the inventive guides can be fabricated in one piece, guides can be made without attachment points (e.g., weld points) that can be sites of failure.

The line guides further would possess significantly greater strength, durability, impact resistance and “memory” than many conventional line guides. These line guides are stronger and less likely to break or deflect to an undue degree during fishing, handling or storage. For example, a guide made from a conventional metal formulation may permanently deflect 90 or more degrees under a load stress. In contrast, a guide in accordance with the present invention may deflect only 10 degrees under similar conditions. Because of the superior strength of metallic glasses, line guides made from these materials can be fabricated with finer and/or smaller structures.

Even if a load were severe enough to cause more significant deflection, the line guides of the present invention benefit from deformation “memory” (i.e., ability to substantially return to its original position). Whereas a conventional guide will tend to permanently deform and risk loss of function, the guides of the present invention will tend to return substantially to the original configuration when the deforming force is removed. The inventive guides thus have a much greater tendency to retain their utility.

Because of the superior strength of metallic glasses, line guides made from these materials can be fabricated with finer and/or smaller structures. As a result, the rod remains crisp and true to its design after the line guides are mounted thereon. Use of the line guides permits the fishing rod to flex more uniformly throughout its entire length. The rod action is significantly enhanced and the tip speed is greatly increased. This would result in higher line speed and improved casting distance.

The line guides of the present invention are very corrosion resistant, even in salt water. In terms of corrosion, therefore, the guides have a much longer service life than a guide made from conventional metal formulations.

In short, the fact that the guides are less susceptible to damage or loss means that, on average, a guide stays in service without need of repair or replacement for longer periods of time. Fishermen will spend less time replacing or repairing lost or damaged guides. Thus, more work or recreation time can be devoted to actual fishing and less to repair and maintenance of the rods bearing the guides.

Metallic glasses often have a lower density than many conventional metal formulations. Thus, the guides of the present invention also can be dramatically lighter than their conventional counterparts. Weight savings of as much as 30% per guide could be observed.

The line guides have very low coefficients of friction, both wet or dry. Consequently, it has been found that casting distance is improved and line wear reduced on fishing rods using guides made from these materials. The resultant increase in casting distance, of course, offers a significant performance advantage for fishing rods employing such components.

The preferred line guides further incorporate a frame with a unique ovate shape. The frames are narrower closer (proximal) to the rod and wider farther (distal) from the rod. This greatly facilitates line handling. The wider area of the frame provides more room for a line to pass through during casting to facilitate easier, longer casting. The narrower region helps to control the line when tensioned to inhibit twisting and enhance control.

In one aspect, the present invention relates to a line guide for a fishing rod. The line guide includes a guide frame provided on a base. The guide frame helps to define an ovate, line guiding aperture. The aperture has a relatively narrow region proximal to the base and a relatively wide region distal from the base.

In another aspect, the present invention relates to a line guide for a fishing rod. The line guide includes a guide frame provided on a base. The line guide is integrally formed in one piece from one or more ingredients including one or more amorphous metallic alloys.

Another aspect of the invention relates to fishing rods incorporating one or more line guides according to one or more aspects of the present invention.

Another aspect of the invention relates to methods of making fishing rods according to one or more aspects of the present invention. The methods include the step mounting at least one line guide onto a fishing rod body. The at least one line guide is in accordance with one or more aspects of the present invention.

Another aspect of the invention relates to methods of fishing. The methods include the step of using a fishing rod to fish. The fishing rod includes at least one line guide mounted on the fishing rod. The at least one line guide is in accordance with one or more aspects of the present invention.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a schematic illustration of a fishing rod incorporating a plurality of line guides incorporating principles of the present invention;

FIG. 2 is a perspective view of a line guide of the present invention used in combination with the fishing rod shown in FIG. 1;

FIG. 3 is an alternative perspective view of the line guide of FIG. 2;

FIG. 4 is an alternative perspective view of the line guide of FIG. 2;

FIG. 5 is an alternative perspective view of the line guide of FIG. 2; and

FIG. 6 is an alternative perspective view of the line guide of FIG. 2.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

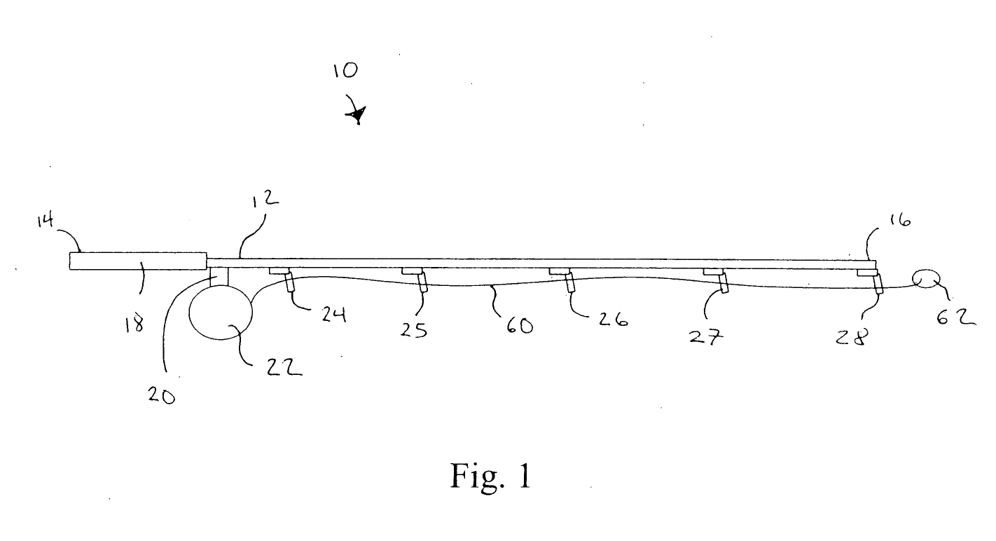

The line guides of the present invention may be used on a wide variety of fishing rod types such as those used for cast fishing, surf fishing, boat fishing, mountain stream fishing and the like, including spinning rods and bait casting rods. For purposes of illustration, FIG. 1 shows a representative spinning rod 10 incorporating one or more line guides 24, 25, 26, 27, and 28 that incorporate principles of the present invention. As shown, rod 10 includes a body 12 extending from butt end 14 to tip 16. Grip 18 is provided at butt end 14, and reel seat 20 is positioned in front of grip 18. Spinning reel 22 is mounted to reel seat 20.

A plurality of line guides is mounted along the length of rod body 12 to help guide fishing line 60 during deployment (e.g., casting or spinning) and recovery (e.g., reeling in) of fishing tackle 62. Any suitable number of such line guides may be used, and most commonly, a typical fishing rod may incorporate from two to 10 of such guides. For purposes of illustration, seven line guides 24, 25, 26, 27, and 28 are shown. Butt guide 24 is located closest to reel seat 20. Tip guide 28 is mounted closest to tip 16. The three line guides 25, 26, and 27 are intermediate guides located between guides 24 and 28.

If desired, the size of the various line guides 24, 25, 26, 27, and 28 may vary. Many conventional line guide approaches involve using line guides of varying size, with the line guides generally becoming smaller moving from butt end 14 to tip 16. Of course, this approach may be utilized when practicing the principles of the present invention. However, it is a distinct advantage of the present invention that all of the line guides 24, 25, 26, 27, and 28 mounted to rod body 12 may be of the same size. This greatly simplifies many aspects of fishing rod manufacture, use, maintenance, and repair, as one need not keep and use an inventory of line guides of varying sizes.

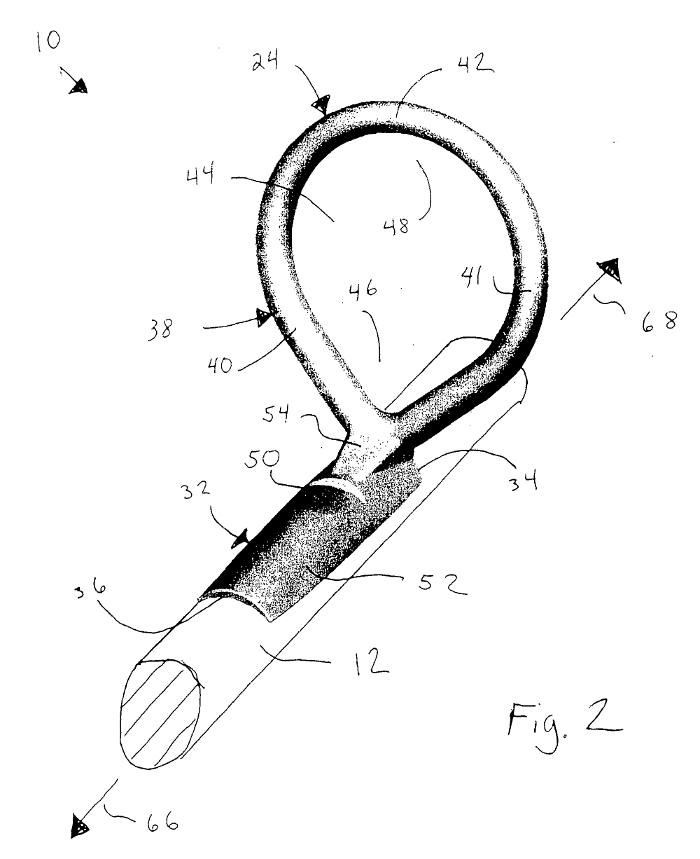

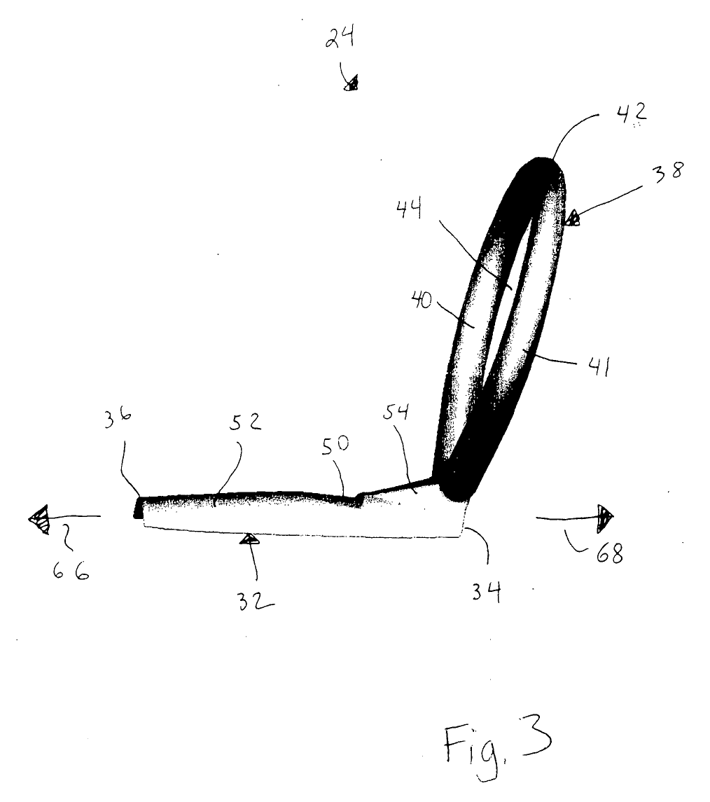

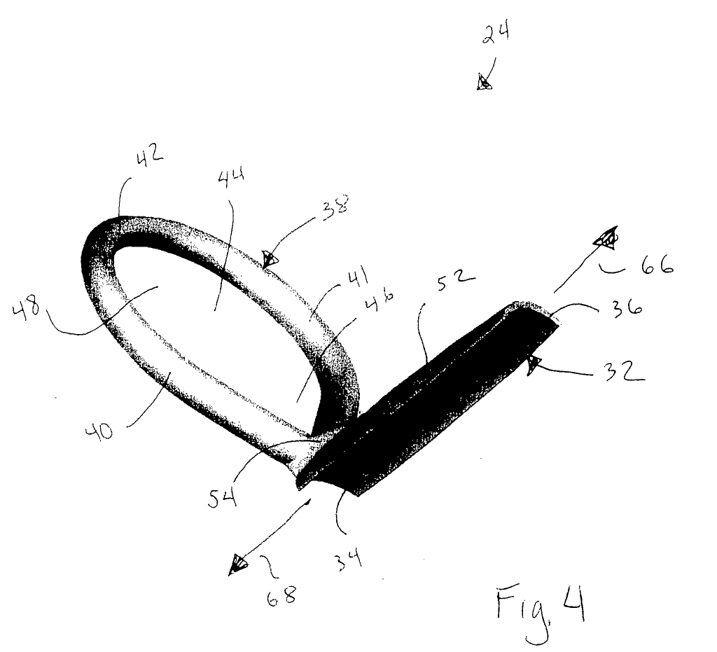

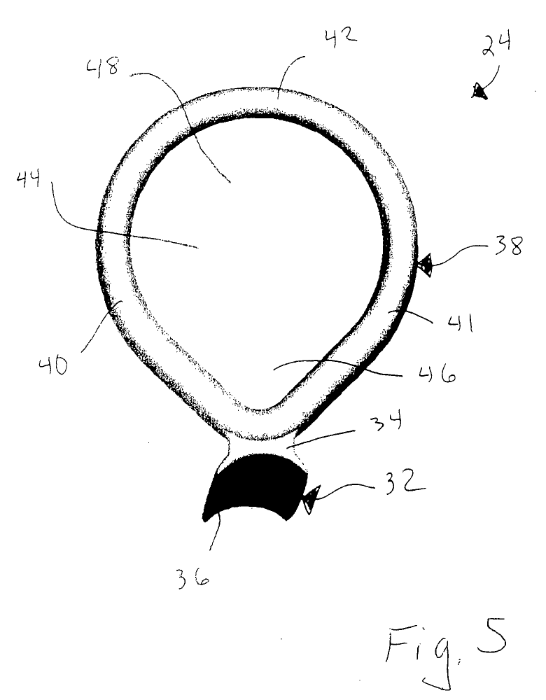

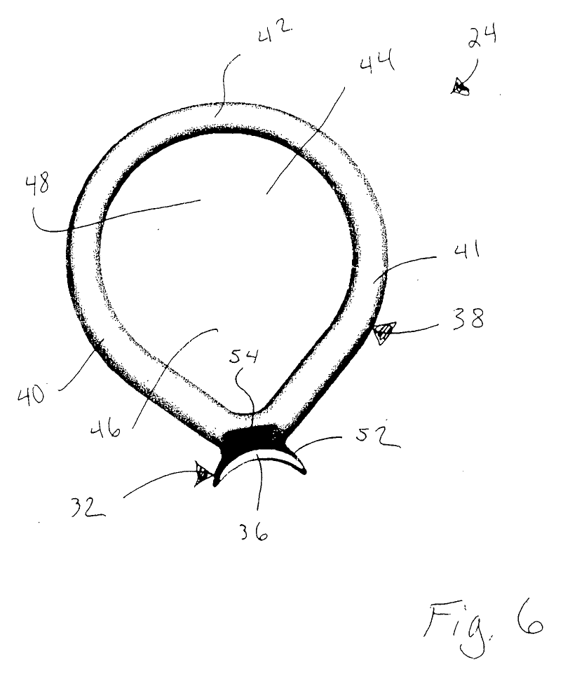

FIGS. 2 through 6 thus show a preferred embodiment of line guide 24 in more detail, with the other line guides 25, 26, 27, and 28 being the same. Arrow 66 designates the direction toward butt end 14 (shown in FIG. 1), while arrow 68 designates the direction toward tip 16 (shown in FIG. 1). Line guide 24 generally includes guide frame 38 projecting upward from base 32. Preferably, guide frame 38 is angled forward toward tip 16 as shown, but other angles may be used if desired. For instance, guide frame 38 may tilt forward toward tip 16 at lesser or greater angles. Alternatively, guide frame 38 may be generally perpendicular to base 32 or may even be angled backward toward butt end 14.

Base 32 extends from first end 34 to second end 36. An optional forefoot region (not shown) could extend forward farther in front of guide frame 38 (i.e., frame 38 could be positioned further rearward on base 32 away from first end 34), but in this embodiment frame 38 is supported on base 32 at first end 34. Hind foot region 52 of base 32 extends rearward toward second end 36 behind guide frame 38. Brace 54 reinforces the connection between base 32 and guide frame 38.

Guide frame 38 includes sidewall 40, 41, and arcuate top 42. Sidewalls 40 and 41 generally diverge upward towards arcuate top 42, thus defining ovate aperture 44 having relatively narrow aperture region 46 proximal to base 32 and relatively wide aperture region 48 distal from base 32.

The ovate shape of aperture 44 provides significant performance advantages. When deploying line 60 and terminal tackle 62, such as by casting or spinning, line 60 will tend to spiral as it is deployed from reel. This spiraling action occurs not only with spinning rods such as rod 10, but also rods of the bait casting type. The spiral action tends to be greater closer to butt end 14. Also during deployment, the line 60 will have a tendency to be closer to arcuate top 42 and farther from rod body 12. Thus, line 60 will tend to travel through wider region 48 of ovate aperture 44 during deployment, and the wider region 48 provides more room to accommodate this spiraling action and help line 37 to become straight by the time it extends through line guide 28 at tip 16.

Conversely, when line 60 is tensioned, line 60 tends to be closer to rod body 12 and farther from arcuate top 42. Thus, line will tend to travel through the narrow region 46 of ovate aperture 44 much closer to rod body 12. This desirably helps to constrain line 60 during tensioning and enhances feel by the user. Also significantly, the ovate shape of aperture 44 is universal in the first sense that it may be used on either bait casting rods or spinning rods. This contrasts to many conventional line guides that are more suitable for one of these rod types, but not both. In a second sense, the ovate shape also allows the line guide to be positioned near the butt, near the tip, or intermediately. This contrasts to many conventional line guide systems that generally use multiple sizes of line guides on the same rod.

In short, line 60 tends to occupy different regions of ovate aperture 44 depending upon whether line 60 is being deployed or tensioned. Advantageously, the present invention exploits this difference in a manner such that the region distal from rod body 12 through which line 60 tends to be deployed is shaped to facilitate deployment, while the region that tends to be occupied by line 60 during tensioning is shaped to facilitate tensioning activities and feel. Thus, the ovate shape of aperture 44 in a simple, elegant, and significant fashion provides at least dual line handling functionalities in a single line guide design. Conventional line guides generally do not offer a single guiding aperture with customized shape regions specially adapted to deployment activities or tensioning activities, respectively.

Line guide 24 (as well as the other line guides 25, 26, 27, and 28) may be secured to rod body 12 in any desired fashion. One suitable approach involves wrapping base 32 to rod body 12 using suitable thread or line (not shown). The resultant windings (not shown) may then be protected with a coating of epoxy, polyurethane, lacquer, or the like. To help hold the windings in place on base 32, base 32 may be provided with one or more surface features, such as depression 50, to help hold the windings in place.

The components of line guide 24 (and/or any of the other line guides 25, 26, 27, and 28) are not limited to any specific construction and may be formed from separate parts that are assembled or formed integrally as a single part. If assembled from two or more components, these may be assembled using an adhesive, welding, or any suitable assembly approach. More preferably, though, line guide 24 (and/or any of the other line guides 25, 26, 27, and 28 ) is integrally formed in one piece, such as by molding, casting, or the like.

The integral construction approach is highly preferred, especially when the line guide 24 (and/or any of the other line guides 25, 26, 27, and 28) is made from one or more materials comprising one or more amorphous metallic alloy(s), also commonly referred to as metallic glasses. The striking characteristic of amorphous metallic alloys is that they have an amorphous atomic structure. These amorphous materials generally have no discernable patterns in their atomic structures. In contrast, the atomic structure of ordinary or conventional crystalline metals and alloys generally is periodic, where the layout of atomic elements shows repeating patterns over an extended range. The amorphous atomic structure leads to many benefits, including high yield strength, high hardness, very high strength to weight ratio, superior elastic limit, high corrosion resistance, high wear resistance, and relatively low surface friction. For example, a particularly preferred embodiment of amorphous metallic alloys commercially available from LIQUIDMETAL® Technologies (Lake Forest, Calif.) have very high yield strengths, which the manufacturer states approach the theoretical limit and far exceeds the strength currently available in crystalline metals and alloys. For example, according to the manufacturer, yield strength of over 250 ksi has been achieved in Zr-base and Ti-base LIQUIDMETAL® alloys (VIT-001 series). This is stated to be more than twice the strength of conventional titanium alloys.

A unique characteristic of amorphous metallic alloys such as those commercially available from LIQUIDMETAL® Technologies, is the availability of superior mechanical properties in as-cast form. This characteristic allows line guides of the present invention to be easily fabricated in a single piece using casting and molding techniques. The ability to mold superior line guides is not as easily achieved with respect to conventional metals where the as-cast forms have inferior mechanical properties compared to their wrought and forged forms.

According to one approach, a metallic glass is formed by solidification of alloy melts by cooling the alloy to a temperature below its glass transition temperature at a cooling rate sufficient to substantially prevent appreciable nucleation and crystallization. Such cooling rates can be on the order of 10⁴ to 10⁶ K/sec. This helps to overcome the tendency of metals and alloys to crystallize when cooled from the liquid phase.

The resistance of a metallic glass to crystallization can be related to the cooling rate required to form the glass upon cooling from the melt. This is an indication of the stability of the amorphous phase upon heating above the glass transition temperature during processing. It is desirable that the cooling rate required to suppress crystallization be in the order of from 1 K/s to 10³ K/s or even less. As the critical cooling rate decreases, greater times are available for processing and larger cross sections of parts can be fabricated. Further, such alloys can be heated substantially above the glass transition temperature without crystallizing during time scales suitable for industrial processing.

Amorphous alloys of zirconium and/or titanium, copper and/or nickel, other transition metals and beryllium are preferred as these demonstrate relatively high resistance to crystallization so that less restrictive cooling rates can be utilized to help form amorphous bodies of substantial thickness. That is, the critical cooling rate is less than 10³ K/s so that thick amorphous bodies can be cast, injection molded, or the like. Preferably, a metallic glass formulation for use in the present invention has a critical cooling rate less than 10³ K/s.

Preferred metallic glass formulations for use in the present invention include formulations that are known as a bulk-solidifying amorphous alloys. The term “bulk-solidifying amorphous alloys” refers to a family of amorphous alloys that may be cooled at rates of about 500 K/sec or less from their molten state to form objects having thicknesses of 1.0 mm or more while maintaining a substantially amorphous atomic structure. The ability of bulk-solidifying amorphous alloys to form objects having thicknesses of 1.0 mm or greater is a substantial improvement on conventional amorphous alloys, which are typically limited to articles having thicknesses of 0.020 mm, and/or which require cooling rates of 105 K/sec or more. Bulk-solidifying amorphous alloys, when properly formed from the molten state at sufficiently fast cooling rates, have high elastic limit typically in the range of from 1.8% to 2.2%. Further, these amorphous alloys may show bending ductility ranging from a few percent in samples of 0.5 mm thick or more to as high as 100% as in some cases. Methods of making feedstocks of bulk-solidifying amorphous alloys are known. An exemplary method of making bulk-solidifying alloy for use in the present invention is disclosed in, e.g., U.S. Pub. No. 2003/0075246, the entirety of which is incorporated herein by reference.

Preferred metallic glass formulations for use in the present invention include metallic glass formulations commercially available from LIQUIDMETAL® Technologies of Lake Forest, Calif. Representative embodiments of metallic glass formulations include Zr—Ti based metallic glass formulations. As used herein, the term “Zr—Ti based” is understood as incorporating those bulk-solidifying amorphous alloy compositions wherein the total of Zr and Ti comprises the largest atomic percentage of metal components in the subject alloy composition. Metallic glass formulations and methods of using such formulations are further described in, e.g., U.S. Pat. Nos. 6,875,293; 6,843,496; 6,875,293; 6,818,078; 6,771,490; 6,446,558; 6,682,611; 5,032,196; 5,288,344; 5,368,659; 5,618,359; and 5,735,975, all of which patents are incorporated herein by reference in their respective entireties.

Rod action refers to the flex characteristics of rod body 12. Generally, the flexibility of a rod decreases when one or more line guides are attached to it. A line guide with a longer, larger base tends to decrease flexibility more than a line guide with a shorter, smaller base. Larger bases also tend to increase the weight of rod 10. This suggests that it is desirable to use shorter, smaller bases. Yet, if a base of a line guide is too small, such a base might not be as strong as might be desired to properly support its associated guide frame. Balancing such concerns, it is desirable that a base be as short as practical while maintaining adequate strength for supporting its guide frame. Advantageously, the design of line guide 24 allows base 32 to be relatively short and strong, especially in preferred embodiments that are made from glassy (amorphous) metal alloys.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A line guide for a fishing rod, comprising a guide frame provided on a base, said guide frame helping to define an ovate, line guiding aperture, said aperture having a relatively narrow region proximal to the base and a relatively wide region distal from the base.

2. The line guide of claim 1, wherein the line guide is made from one or more ingredients comprising one or more amorphous metallic alloys.

3. The line guide of claim 1, wherein the line guide is made from one or more ingredients consisting essentially of one or more amorphous metallic alloys.

4. The line guide of claim 1, wherein the line guide is made from one or more ingredients consisting of one or more amorphous metallic alloys.

5. The line guide of claim 1, wherein the base comprises a hind foot.

6. The line guide of claim 1, wherein the base comprises a forefoot.

7. The line guide of claim 1, wherein the guide frame is positioned at an end of the base.

8. The line guide of claim 1, wherein the guide frame is tilted so as to be non-perpendicular with respect to the base.

9. A fishing rod comprising at least one line guide according to claim 1, wherein said line guide is mounted on the fishing rod.

10. A method of making a fishing rod, comprising mounting at least one line guide according to claim 1 onto a fishing rod body.

11. A method of fishing, comprising using a fishing rod to fish, said fishing rod comprising at least one line guide according to claim 1 mounted on the fishing rod.

12. A line guide for a fishing rod, comprising a guide frame provided on a base, said line guide being integrally formed in one piece from one or more ingredients comprising one or more amorphous metallic alloys.

13. The line guide of claim 12, wherein the line guide is made from one or more ingredients consisting essentially of one or more amorphous metallic alloys.

14. The line guide of claim 12, wherein the line guide is made from one or more ingredients consisting of one or more amorphous metallic alloys.

15. The line guide of claim 12, wherein the base comprises a hind foot.

16. The line guide of claim 12, wherein the base comprises a forefoot.

17. The line guide of claim 12, wherein the guide frame is positioned at an end of the base.

18. The line guide of claim 12, wherein the guide frame is tilted so as to be non-perpendicular with respect to the base.

19. A fishing rod comprising at least one line guide according to claim 12, wherein said line guide is mounted on the fishing rod.

20. A method of making a fishing rod, comprising mounting at least one line guide according to claim 12 onto a fishing rod body.
